(19) United States
(12) Patent Application Publication
(10) Pub. No.: US 2012/0292806 A1
(43) Pub. Date: Nov. 22, 2012

(54) METHOD OF MAKING THREE-DIMENSIONAL ETHYLENE-VINYL ACETATE PRODUCTS

(75) Inventor: Yuen Mou Law, Hong Kong (CN)

(73) Assignee: MAGIC LAND LIMITED, Hong Kong (CN)

(21) Appl. No.: 13/109,992

(22) Filed: May 17, 2011

(51) Int. Cl. B29C 43/18

(52) U.S. Cl. 264/132

(57) ABSTRACT

Embodiments of the present invention are directed to a method of making a three-dimensional ethylene-vinyl acetate (EVA) product. According to one embodiment, the method includes providing an EVA sheet; cutting the EVA sheet into a predetermined two-dimensional shape; applying an image the EVA sheet; inserting the EVA sheet into a molding machine; molding the EVA sheet in the molding machine, wherein the EVA sheet is molded into a three-dimensional EVA product; and removing the three-dimensional EVA product from the molding machine. One example EVA product is a hat molded into a semi-spherical shape. During finishing, a pair of circular-shaped decorative components may be affixed to a surface of the semi-spherical EVA product to create the appearance of a hat having ears.

### FIELD OF THE INVENTION

The present invention relates to ethylene-vinyl acetate processing, and more particularly, a method of making three-dimensional products using ethylene-vinyl acetate.

### BACKGROUND OF THE INVENTION

Previously, many consumer goods, such as hats and clothing, were made from fabric or paper that was either sown or glued together. Because of the softness of cloth and paper, it was difficult or impossible to produce consumer goods having certain desirable designs.

Ethylene-vinyl acetate (“EVA”) is a polymer that has a softness and flexibility similar to other elastomeric materials. EVA, also known as expanded rubber or foam rubber, can have certain desirable qualities such as good clarity and gloss, barrier properties, low-temperature toughness, stress-crack resistance, hot-melt adhesive water proof properties, and resistance to UV radiation. Additionally, EVA has little or no odor and has good protective and floatation properties, making it popular in sports equipment.

Therefore, existing methods for making consumer products have these and other limitations. Accordingly, there is a need for a method of making EVA consumer goods that solves these and other shortcomings of existing methods.

### SUMMARY OF THE INVENTION

According to one embodiment of the present invention, a method of making a three-dimensional ethylene-vinyl acetate (EVA) product is disclosed. The method includes providing an EVA sheet; cutting the EVA sheet into a predetermined two-dimensional shape; applying an image the EVA sheet; inserting the EVA sheet into a molding machine; molding the EVA sheet in the molding machine, wherein the EVA sheet is molded into a three-dimensional EVA product; and removing the three-dimensional EVA product from the molding machine.

According to another embodiment of the present invention, a method of making a three-dimensional ethylene-vinyl acetate (EVA) product is disclosed. The method includes providing an EVA sheet; cutting the EVA sheet into a two-dimensional shape; applying an image the EVA sheet; inserting the EVA sheet into a molding machine; molding the EVA sheet in the molding machine, wherein the EVA sheet is molded into a three-dimensional EVA product; removing the three-dimensional EVA product from the molding machine; removing excess material from the three-dimensional EVA product; and applying a trim to edges of the three-dimensional EVA product. The method may further include attaching one or more decorative components to a surface of the three-dimensional EVA product.

According to another embodiment of the present invention, a method of making a three-dimensional ethylene-vinyl acetate (EVA) hat is disclosed. The method includes providing an EVA sheet; cutting the EVA sheet into a two-dimensional round shape; applying an image the EVA sheet; inserting the EVA sheet into a molding machine; molding the EVA sheet in the molding machine, wherein the EVA sheet is molded into a semi-spherical EVA product; removing the semi-spherical EVA product from the molding machine; removing excess material from the semi-spherical EVA product; applying a trim to edges of the semi-spherical EVA product; and attaching a pair of circular-shaped decorative components to a surface of the semi-spherical EVA product.

Still other embodiments of the present invention will become readily apparent to those skilled in the art from the following detailed description, wherein embodiments of the invention are described by way of illustration. As will be realized, the invention is capable of other and different embodiments and its several details are capable of modifications in various respects, all without departing from the spirit and the scope of the present invention.

### BRIEF DESCRIPTION OF THE DRAWINGS

FIG. 1 is a flow diagram of a method of making a three-dimensional EVA product, in accordance with one embodiment of the present invention.

FIG. 2 is a flow diagram of a method of making a three-dimensional EVA hat, in accordance with another embodiment of the present invention.

FIG. 3 is a front view of an example three-dimensional EVA product, in accordance with one embodiment of the present invention.

FIG. 4 is a top view of the example EVA product shown in FIG. 2, in accordance with one embodiment of the present invention.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the present invention. Also, the various embodiments and aspects from each of the various embodiments may be used in any suitable combinations. Accordingly, the drawings and detailed description are to be regarded as illustrative in nature and not as restrictive. Like elements in each of the figures are referred to by like reference numbering.

Generally, embodiments of the present invention are directed to a method of making three-dimensional ethylene-vinyl acetate (EVA) products. An EVA sheet is molded into a desired three-dimensional shape using thermal molding or any other suitable plastic forming method. The three-dimensional shape may then be finished to create a finished consumer product, such as a hat, toy, novelty, or other product.

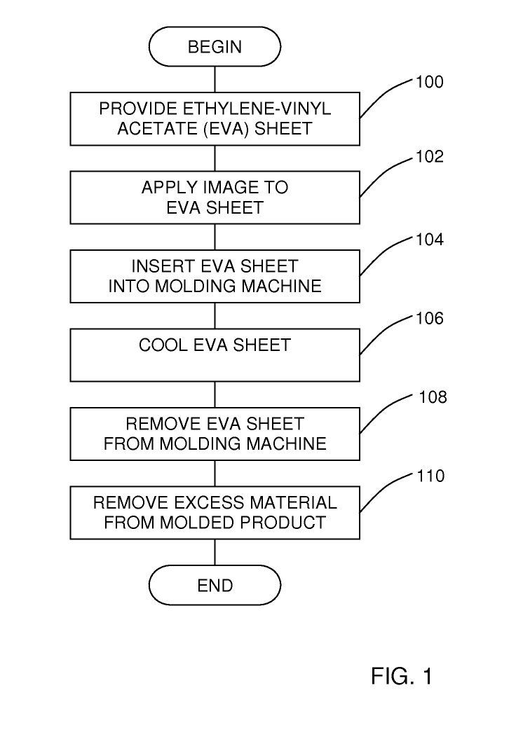

Referring now to the figures, FIG. 1 is a flow diagram of a method of making a three-dimensional EVA product, in accordance with one embodiment of the present invention. In step 100, an EVA sheet is provided and cut into a predetermined two-dimensional shape for further processing. The predetermined two-dimensional shape may be any desired shape that will result in the desired finished product. The EVA sheet may also need to be cut into the predetermined two-dimensional shape so that it can fit into a molding machine. In step 102, an image is applied to the EVA sheet, if desired. The image may be applied by any suitable method, such as inkjet or electrostatic printing, or heat transfer printing. If no image is desired, then step 102 may be omitted. In step 104, the EVA sheet is inserted into the molding machine. The molding machine may be any suitable device configured to mold EVA materials. Once the EVA sheet is inserted into the molding machine, the EVA sheet is molded in the molding machine into a three-dimensional EVA product. According to one embodiment, the EVA sheet is compressed at 266 degrees Fahrenheit (about 130 degrees Celsius). According to another embodiment, the EVA sheet is compressed at between 260 and 270 degrees Fahrenheit (between about 126 and about 130 degrees Celsius). According to yet another embodiment, the EVA sheet is compressed at between 250 and 280 degrees Fahrenheit. The EVA sheet may be compressed at any suitable temperature outside of these temperatures. The compression temperature can be adjusted according to the type and thickness of the EVA sheet being used.

According to one embodiment, the EVA sheet is compressed for 4 minutes. According to another embodiment, the EVA sheet is compressed for between 3 and 5 minutes. The compression time may be varied depending on the temperature used and the type and thickness of the EVA sheet being used.

In step 106, the three-dimensional EVA product and the molding machine are cooled prior to opening the molding machine and removing the three-dimensional EVA product. According to one embodiment, the three-dimensional EVA product is cooled for at least 10 minutes. An intercooler may be used to cool the three-dimensional EVA product and fix the EVA into the desired three-dimensional shape. In step 108, the molding machine is opened and the three-dimensional EVA product is removed from the molding machine. If necessary, in step 110, excess material is removed from the three-dimensional EVA product by cutting or trimming.

Depending on the type of product being produced by the above process, additional finishing may be performed. For example, in one embodiment, a trim is applied to the edges of the three-dimensional EVA product and one or more decorative components are attached to the surface of the three-dimensional EVA product.

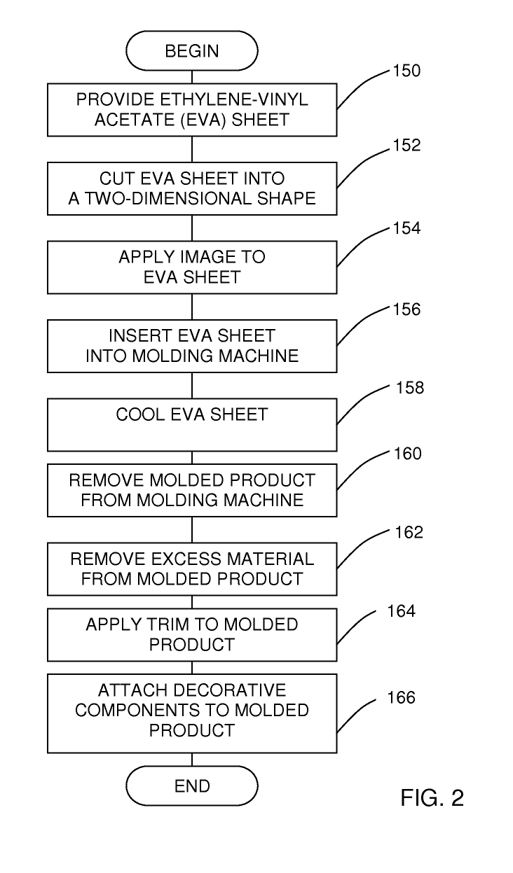

FIG. 2 is a flow diagram of a method of making a three-dimensional EVA hat, in accordance with another embodiment of the present invention. In step 150, an EVA sheet is provided and cut into a predetermined two-dimensional shape for further processing. According to one embodiment, the EVA sheet is cut into a shape and a size that is appropriate for the molding machine being used, step 152. For example, one suitable shape for the product of this embodiment is a round shape. In step 154, an image is applied to the EVA sheet. In step 156, the EVA sheet is inserted into the molding machine. The mold is configured to produce a semi-spherical product. Once the EVA sheet is inserted into the molding machine, the EVA sheet is molded in the molding machine into a three-dimensional semi-spherical product. In step 158, the three-dimensional semi-spherical product and the molding machine are cooled prior to opening the molding machine and removing the three-dimensional semi-spherical product. In step 160, the molding machine is opened and the three-dimensional semi-spherical product is removed from the molding machine. In step 162, any excess material is removed from the three-dimensional semi-spherical product by cutting or trimming. In step 164, a trim is applied to the edges of the three-dimensional semi-spherical product. In step 166, one or more decorative components are attached to the surface of the three-dimensional semi-spherical product. In one embodiment, the one or more decorative components are a pair of generally circular pieces of plastic that protrude perpendicularly from the three-dimensional semi-spherical product to give the appearance of a hat having ears.

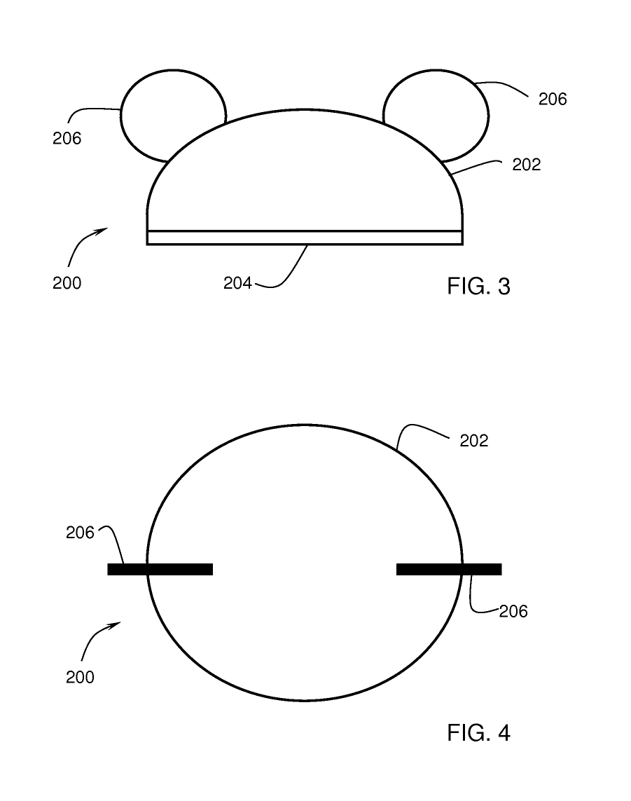

FIG. 3 is a front view of an example three-dimensional EVA product, in accordance with one embodiment of the present invention. The example three-dimensional EVA product 200 is a hat 202 having ears 206 attached to the hat 202 to provide the appearance of a mouse or other animal. The hat 202 may have an image (not shown) on the surface of the hat 202 and a trim 204 attached to the opening edge of the hat 202. The trim 204 may be sown to the hat 202, glued using a suitable adhesive, or attached by any other suitable method.

FIG. 4 is a top view of the example three-dimensional EVA product shown in FIG. 3, in accordance with one embodiment of the present invention. The hat 202 and ears 206 may be seen on the example consumer product 200.

In one embodiment, the ears 206 are made from rigid plastic and they are attached to the hat 202 using an adhesive. They may also be sown or attached by other suitable methods. Because the use of EVA gives the hat 202 a degree of rigidity, being flexible yet sufficiently strong to keep its shape, components, such as the ears 206, may be attached and propped up from the surface of the EVA product 200. Other consumer products may be similarly made according to embodiments of the present invention.

The use of EVA, therefore, provides a firm surface to which auxiliary components, such as the ears, may be propped up in the desired configuration to create the required appearance. The use of EVA also creates products that are comfortable for the user to wear or use. The finished product is generally resilient in that it will return to its original, molded shape if it is smashed or bent, such as may be necessary for shipping and packaging. Also, printing may be made on a generally flat surface prior to shaping of the product.

While the invention has been particularly shown and described with reference to the illustrated embodiments, those skilled in the art will understand that changes in form and detail may be made without departing from the spirit and scope of the invention. For example, while thermoplastic molding is illustrated and described, a plastic blister process may be used to create the shape of the desired consumer product. Also, while certain printing methods were described, three-dimensional printing on the surface of the consumer product may be used. Also, while EVA is used and described in example embodiments of the present invention, other similar polymer materials exhibiting similar properties may also be used.

Accordingly, the above description is intended to provide example embodiments of the present invention, and the scope of the present invention is not to be limited by the specific examples provided.

What is claimed is:

1. A method of making a three-dimensional ethylene-vinyl acetate (EVA) product, the method comprising:
providing an EVA sheet;
cutting the EVA sheet into a predetermined two-dimensional shape;
applying an image the EVA sheet;
inserting the EVA sheet into a molding machine;
molding the EVA sheet in the molding machine, wherein the EVA sheet is molded into a three-dimensional EVA product; and
removing the three-dimensional EVA product from the molding machine.

2. The method of claim 1, further comprising finishing the three-dimensional EVA product.

3. The method of claim 2, wherein finishing includes removing excess material from the three-dimensional EVA product.

4. The method of claim 3, wherein finishing further includes applying a trim to edges of the three-dimensional EVA product.

5. The method of claim 3, wherein finishing further comprising attaching one or more decorative components to a surface of the three-dimensional EVA product.

6. The method of claim 5, wherein the one or more decorative components are ear-shaped pieces.

7. The method of claim 1, wherein applying the image includes applying the image using inkjet printing.

8. The method of claim 1, wherein applying the image includes applying the image using electrostatic printing.

9. The method of claim 1, wherein molding the EVA sheet includes compressing the EVA sheet in the molding machine at 266 degrees Fahrenheit.

10. The method of claim 1, wherein molding the EVA sheet includes compressing the EVA sheet in the molding machine at a temperature within the range of 260 degrees Fahrenheit and 270 degrees Fahrenheit.

11. The method of claim 1, wherein molding the EVA sheet includes compressing the EVA sheet in the molding machine at a temperature within the range of 250 and 280 degrees Fahrenheit.

12. The method of claim 1, wherein molding the EVA sheet includes compressing the EVA sheet in the molding machine for 4 minutes.

13. The method of claim 1, wherein molding the EVA sheet includes compressing the EVA sheet in the molding machine for a period of time with the range of 3 minutes and 5 minutes.

14. The method of claim 1, further comprising cooling the three-dimensional EVA product prior to removing the three-dimensional EVA product from the molding machine.

15. The method of claim 1, wherein the molded shape is cooled for at least 10 minutes.

16. A method of making a three-dimensional ethylene-vinyl acetate (EVA) product, the method comprising:
providing an EVA sheet;
cutting the EVA sheet into a two-dimensional shape;
applying an image the EVA sheet;
inserting the EVA sheet into a molding machine;
molding the EVA sheet in the molding machine, wherein the EVA sheet is molded into a three-dimensional EVA product;
removing the three-dimensional EVA product from the molding machine;
removing excess material from the three-dimensional EVA product; and
applying a trim to edges of the three-dimensional EVA product.

17. The method of claim 16, further comprising attaching one or more decorative components to a surface of the three-dimensional EVA product.

18. A method of making a three-dimensional ethylene-vinyl acetate (EVA) hat, the method comprising:
providing an EVA sheet;
cutting the EVA sheet into a two-dimensional round shape;
applying an image the EVA sheet;
inserting the EVA sheet into a molding machine;
molding the EVA sheet in the molding machine, wherein the EVA sheet is molded into a semi-spherical EVA product;
removing the semi-spherical EVA product from the molding machine;
removing excess material from the semi-spherical EVA product;
applying a trim to edges of the semi-spherical EVA product; and
attaching a pair of circular-shaped decorative components to a surface of the semi-spherical EVA product.
